(19) United States
(12) Patent Application Publication
(10) Pub. No.: US 2005/0287330 A1
(43) Pub. Date: Dec. 29, 2005

(54) Mat system with replaceable logo

(76) Inventor: Ronald N. Kessler, Girard, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/874,504

(22) Filed: Jun. 23, 2004

(51) Int. Cl. B32B 3/10

(52) U.S. Cl. 428/44

(57) ABSTRACT

A floor mat system has a first mat defining an opening in which a logo mat is removably disposed. Advertising indicia is formed on the upper surface of the logo mat. The first mat and logo mat are removably connected to the floor with clips mounted on the floor. The first mat and logo mat each have sets of first and second ribs extending transversely to one another to create drainage openings therebetween. The lower surfaces of the second ribs are spaced from the floor to create drainage channels below the first mat and logo mat. The second rib upper surfaces are raised above the first rib upper surfaces to provide a suitable surface for scraping debris from the bottom of shoes. A frame assembly includes an outer frame member surrounding the first mat and an inner frame member disposed within the first mat opening and surrounding the logo mat.

### BACKGROUND OF THE INVENTION

1. Technical Field

The invention relates generally to floor mat systems. More particularly, the invention relates to floor mat systems having removable and replaceable floor mats. Specifically, the invention relates to such floor mats having replaceable logos.

2. Background Information

Floor mats incorporating logos or various indicia are known and have been used residentially as well as commercially. While the concept of including writing or figures in conjunction with such mats is old, there nonetheless remains a need for floor mats with removable logo sections particularly for the purpose of advertising, although other uses are envisioned within the scope of the present invention. Removable logos may be especially useful in facilitating the use of floor mats for advertising on a time unit basis. The floor mat itself may thus remain on the floor while only the logo section is removed and replaced by another logo section. The logo section can either be for a different advertiser or for the same advertiser wanting to provide a cleaner and/or different logo. The use of a removable logo section permits less costly advertising in comparison to replacing the entire mat, as the remainder of the floor mat is retained for continued use. In addition, floor mats having multiple logo sections can be used for advertising by multiple advertisers or may be combined to form a single logo. Removable logo mats may also provide a simple method for cleaning underneath the mat and allowing water and various debris to flow into a drain beneath or adjacent the mat.

There are advertising floor mats which are intended for use on an indoor floor wherein the mat itself also has a flat and generally smooth upper surface. Such mats are adhered to the floor and are rather thin so that they do not create a tripping problem. Further, the flat, slick upper surface of these mats tend to become slippery when wet and are not suitable for outdoor use or in the transition areas between outdoors and indoors where people wipe their feet before entering a commercial building or other structure. Thus, there is a need for a logo mat which may be safely walked upon when wet, which provides an effective mechanism for wiping mud and other debris from shoes, and also provides desirable advertising which may be easily removed and replaced.

### BRIEF SUMMARY OF THE INVENTION

The present invention provides a floor mat system adapted to lie on a floor, the floor mat system having a first mat having an upper surface and a lower surface and defining an opening extending from the upper surface to the lower surface; a logo mat having an upper surface with discernible indicia formed thereon; and the logo mat being removably disposed in the opening.

The present invention also provides a floor mat adapted to lie on a floor; the floor mat having a first mat having an upper surface and a lower surface and defining an opening extending from the upper surface to the lower surface; a logo mat having a perimeter, an upper surface and a lower surface; the logo mat including indicia formed on at least the upper surface thereof; and a frame assembly including at least one inner frame member forming an inner well; the at least one inner frame member being disposed in the opening and the logo mat being removably disposed in the inner well.

### BRIEF DESCRIPTION OF THE SEVERAL VIEWS OF THE DRAWINGS

Preferred embodiments of the invention, illustrative of the best mode in which the applicants have contemplated applying the principles of the invention, are set forth in the following description and are shown in the drawings and are particularly and distinctly pointed out and set forth in the appended claims.

FIG. 1 is an exploded top plan view of a first embodiment of the floor mat of the present invention showing the logo mat prior to insertion in the opening in the first mat;

FIG. 2 is a sectional view taken on line 2-2 of FIG. 1;

FIG. 3 is a top plan view of the first embodiment showing the logo mat inserted in the opening of the first mat;

FIG. 4 is a sectional view taken on line 4-4 of FIG. 3;

FIG. 5 is a sectional view taken on line 5-5 of FIG. 3;

FIG. 6 is a top plan view of a second embodiment of the present invention showing the logo mat inserted in the opening of the first mat;

FIG. 7 is a top plan view of a third embodiment of the present invention showing the two-piece logo mat inserted in the opening of the first mat and including a frame assembly;

FIG. 8 a top plan view of a fourth embodiment of the present invention showing the logo mat inserted in the opening of the first mat and including a frame assembly; and

FIG. 9 is a sectional view of a fifth embodiment of the present invention showing two logo mats inserted in respective openings of the first mat and including a frame assembly.

Similar numbers refer to similar parts throughout the specification.

### DETAILED DESCRIPTION OF THE INVENTION

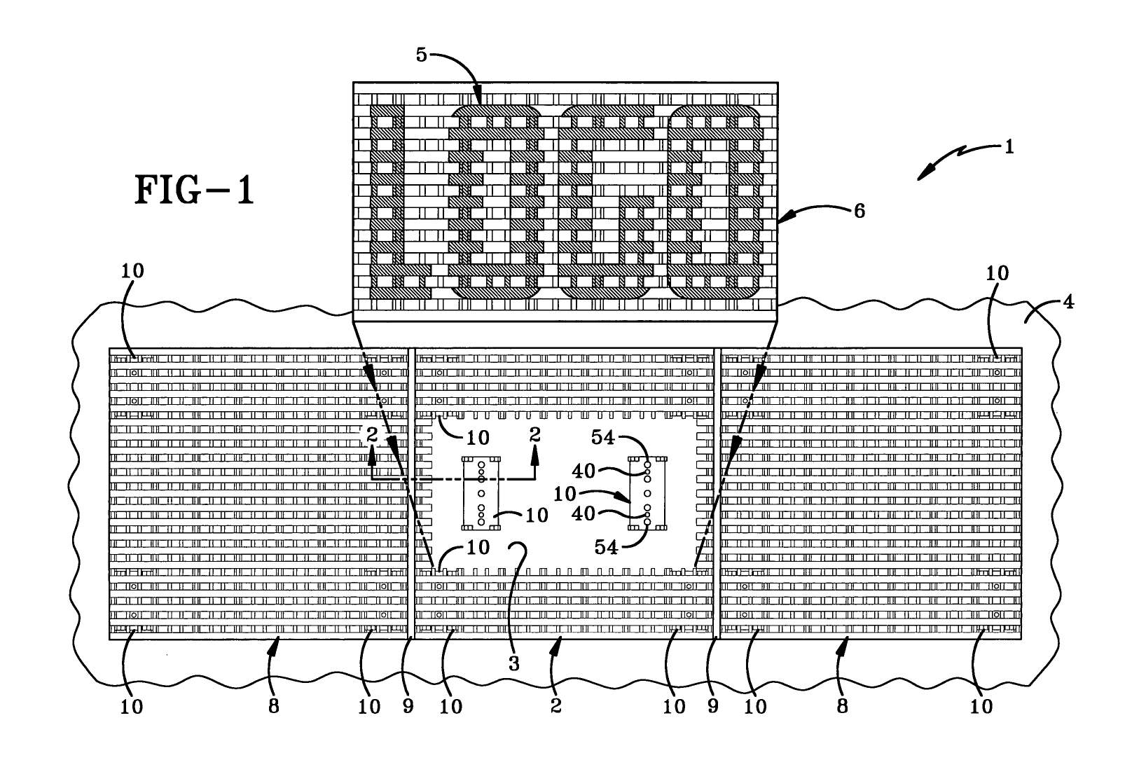

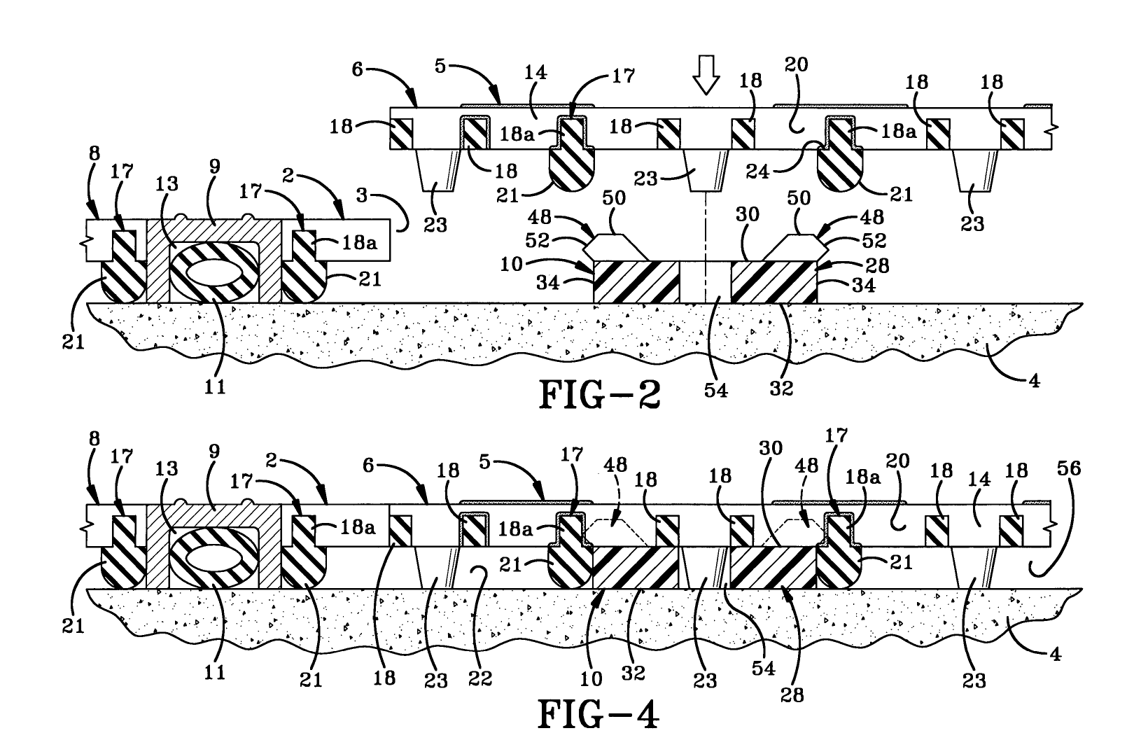

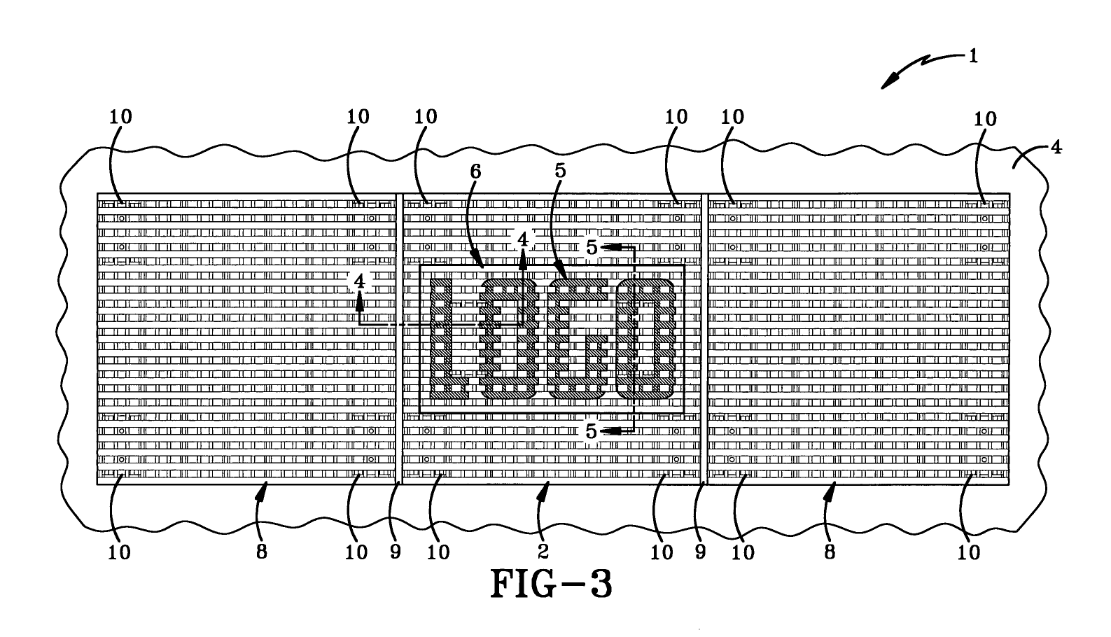

A first embodiment of the floor mat system with a removable logo mat of the present invention is indicated generally at 1 and shown in FIGS. 1-5. System 1 includes a first mat 2 defining a logo mat receiving opening 3, a logo mat 6 and a plurality of clips 10. System 1 may also include additional floor mats 8, inner frame members 9 and seals 11 (FIG. 2) where desired.

Except as otherwise noted herein, first mat 2 and logo mat 6 both include the same structural makeup as floor mats 8, which is further detailed in U.S. Pat. No. 5,882,764, incorporated herein by reference. An abbreviated version of the structural makeup of mats 2, 6 and 8 is given herein with reference only to floor mat 8 for simplicity.

With reference to FIGS. 2, 4 and 5, floor mat 8 includes a plurality of parallel spaced first ribs 14 and a plurality of second spaced ribs 17 extending perpendicular to and between first ribs 14 forming rectangular openings 20 therebetween. Second ribs 17 include a pair of middle ribs 18 which extend between a pair of latching or support ribs 18a. Latching ribs 18a have an enlarged bottom 21 which forms an upwardly facing latching shoulder 24 (FIG. 2) on each side of latching ribs 18a. Second ribs 17 are slightly shorter than first ribs 14 thereby creating a sculptured top surface of floor mat 8. Additionally, enlarged bottom 21 extends substantially below the bottom surface of first ribs 14 and of middle ribs 18 thereby suspending the majority of floor mat 8 above floor 4 and creating drainage channels 22 for water and debris scraped from customer's shoes. A plurality of support knobs 23 extend downwardly from first ribs 14 as further explained below.

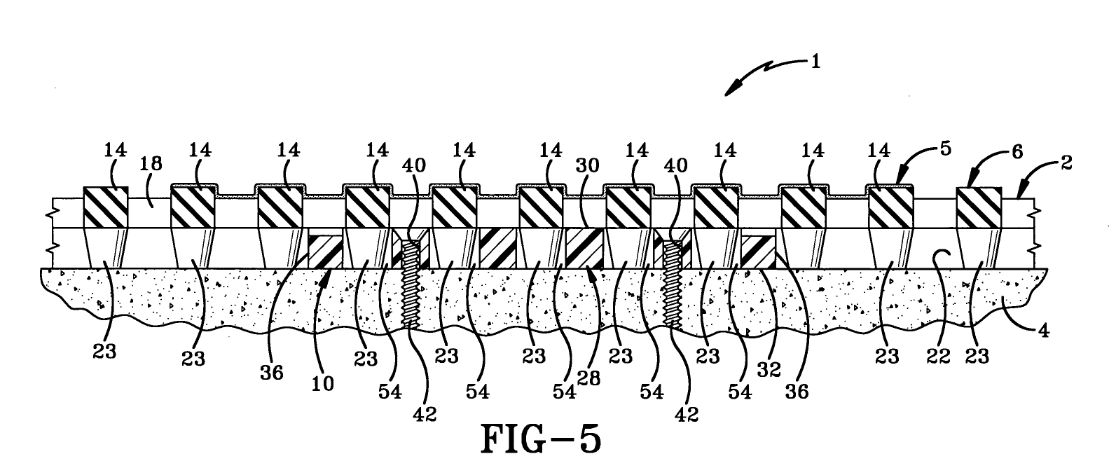

With reference to FIGS. 1, 2, 4 and 5, clip 10 includes a rectangular-shaped base 28 having a top surface 30, a bottom surface 32, sides 34 and ends 36. Base 28 defines holes 40 each aligned with certain of openings 20 and each receiving a screw 42 (FIG. 5) to secure clip 10 to floor 4. Base 28 further defines additional holes 54 for receiving additional screws in the event clip 10 requires further securing to floor 4. A pair of raised projections 48 extends outwardly from each side 34 adjacent each end 36. Projections 48 include a flat top portion 50 and a generally triangular end 52.

Floor mat system 1 may be installed at the entrance of a business, for example, to prevent customers from tracking water or snow on the business' floors. When installing system 1, clip 10 snap-fits to floor mat 8 so that base 28 is disposed between two adjacent latching ribs 18a while projections 48 on either side of clip 10 extend over respective latching shoulders 24 of respective latching ribs 18a (FIG.4). Latching shoulders 24 thus retain clip 10 adjacent the bottom surface of floor mat 8. When system 1 is mounted on floor 4, enlarged bottoms 21 of latching ribs 18a contact floor 4 forming a gap 56 (FIG. 4) between floor 4 and the bottom surface of ribs 14 and 18.

As further detailed in U.S. Pat. No. 6,352,757, incorporated herein by reference, floor mat 8 may further include support knobs 23 that extend down from the lower surface of first ribs 14 and engage floor 4 to provide additional support to floor mat 8. Each support knob 23 is disposed substantially centrally between latching or support ribs 18a although in other embodiments, this location may vary, as described in U.S. Pat. No. 6,352,757. Some support knobs 23 may be received in additional holes 54. Each support knob 23 is substantially the same height as enlarged bottom 21 of support ribs 18a so that support knobs 23 work in cooperation with support ribs 18a to provide support to floor mat 8, particularly when needed for heavy loads on mat 8. Support knobs 23 also allow drainage channels 22 to remain substantially open to allow the flow of water within channels 22 and gathering of debris under floor mat 8.

As noted above, system 1 may also include inner frame members 9 and seals 11 (FIG. 2). Each inner frame member 9 is an elongated rectangular shaped member formed with a generally U-shaped seal receiving recess 13 which receives seal 11. Each inner frame member 9 is disposed between first mat 2 and a respective floor mat 8. Inner frame member 9 has the same structure as inner frame member 230 of the third embodiment of the present invention and is more fully described below.

In accordance with one of the main features of the present invention, logo mat 6 is removably disposed in logo mat receiving opening 3 of first mat 2. Preferably, first mat 2 and logo mat 6 are removably mounted to floor 4 by clips 10, which are mounted on floor 4. More preferably, clips 10 are positioned adjacent the corners of mats 2 and 6 to prevent upturned corners which could be tripping hazards. However, optionally only one of mats 2 and 6 may be held to floor 4 by clips 10 to ground both mats 2 and 6 to prevent them from sliding out of position.

The logo or indicia 5 on logo mat 6 is preferably painted on the upper surfaces of first ribs 14 and second ribs 17 with a durable paint to withstand walking or other traffic over logo mat 6. Alternately, another material may be applied to these upper surfaces to form logo 5, such as an elastomer or a laminate securely attached to logo mat 6 by adhesive, a heat seal or other manner known in the art. Indicia 5 may include multiple colors. A four-colored glued-on laminate, for example, has been found very suitable, being durable, attractive and offering substantial variety for creating a logo. Logo 5 may appear only on the upper surface of first ribs 14 so as to create an image which is easily legible to those walking over or near logo mat 6. Logo 5 may also be applied to the sides of ribs 14 and 17 to help create a more continuous appearance of logo 5 on approaching logo mat 6.

The easily removable nature of logo mat 6 allows rapid removal and replacement of advertising or other messages or images without using an entire mat the size of mats 2 or 8. This is especially useful where first mat 2 is relatively large. Mats 2 and 8 are typically made in four by four foot sections. Thus, instead of replacing an entire mat with a logo on it, the much smaller logo mat 6 is used to reduce costs. In addition, a plurality of logo mats 6 may be inserted into a respective plurality of openings like opening 3 within a single first mat like first mat 3, thus permitting more than one advertisement. Again, where the mats are relatively large, this may be a desirable option.

While the concept of a removable logo mat like logo mat 6 may be applied to a variety of mats having structures different than mat 6, the mats 2, 6 and 8 are preferable as being effective for scraping debris and water off customer's shoes so as to allow the debris and water to drain downwardly through openings 20 and along floor 4 in drainage channels 22. Further, the use of first mats 2 with logo mats 6 permits alignment and communication of their respective drainage channels 22 to facilitate drainage under and between mats 2 and 6. Where inner frame members 9 are used, drainage thereunder may be selectively controlled, as further detailed with regard to the third embodiment below. Further, first mat 2 and logo mat 6 are configured to work in cooperation with clips 10 to effectively hold mats 2 and 6 from slipping out of place while also allowing easy removal for cleaning thereunder and for changing logos.

Though the configurations of mats 2 and 6 are preferable, as noted above, logo mat 6 may also be effective when inserted into any type of mat having an appropriate logo mat receiving opening formed therein. With this option, the mounting on floor 4 of logo mat 6 by clips 10 grounds the other mat. Preferably, the alternate first mat has the same or nearly the same height as logo mat 6 so as to prevent tripping.

A second embodiment of the floor mat system of the present invention is indicated at 100 in FIG. 6 and is similar to system 1 except as otherwise noted herein. System 100 differs from system 1 in the positioning of logo mat 6 adjacent an edge 105 of a first mat 102. Thus, logo mat receiving opening 103 differs from opening 3 in that it is surrounded on only three sides by first mat 102 instead of being completely surrounded. Thus, opening 103 extends inwardly from edge 105 of first mat 102 and edge 105 is separated by opening 103 into two segments. Logo mat 6 includes an outer edge 7 which aligns with the segments of edge 105 to form in combination therewith a continuous side, although other embodiments may include a logo mat which extends inwardly or outwardly from edge 105.

It will be appreciated that an opening similar to opening 103 could be formed in a corner of a similar first mat such that the opening would be bounded by two sides or even one side which may be curved. Further, the shape of the logo mat and corresponding opening may vary without departing from the spirit of the invention.

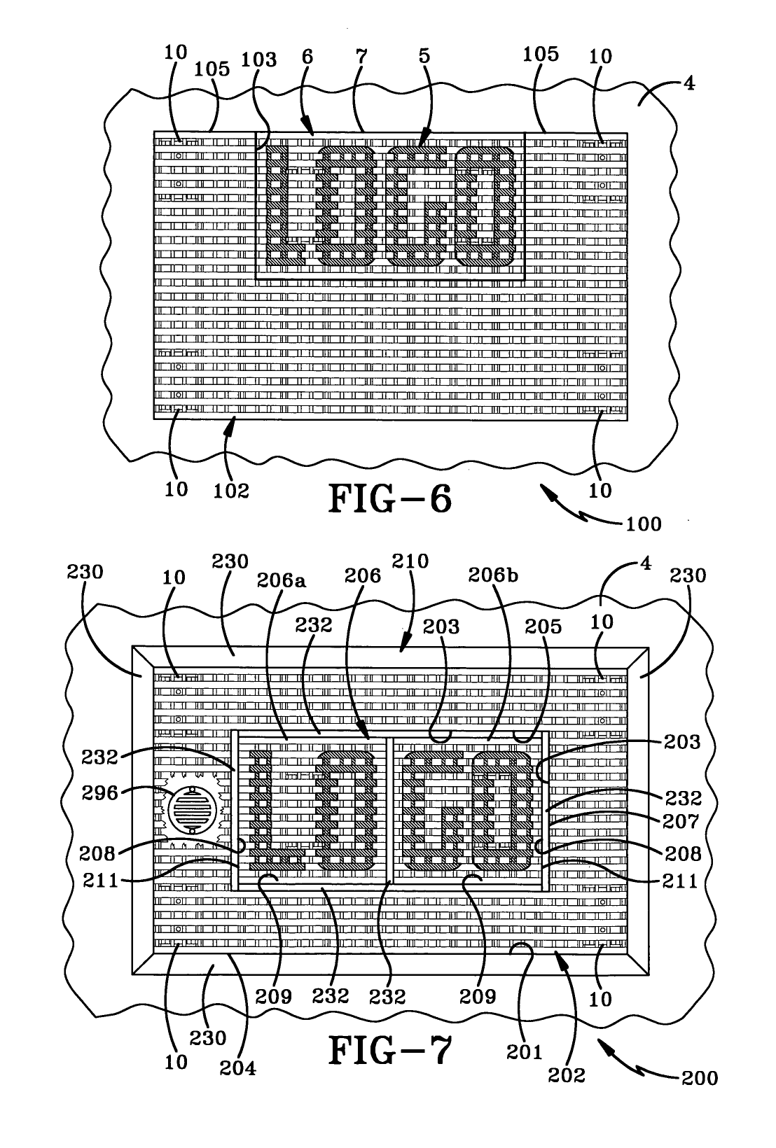

A third embodiment of the floor mat system of the present invention is indicated at 200 in FIG. 7. System 200 includes a frame assembly 210 which is further detailed in U.S. Pat. No. 5,958,538, incorporated herein by reference. Frame assembly 210 includes outer frame members 230 and inner frame members 232.

In accordance with one of the main features of the present invention, a removable logo mat 206 used with frame assembly 210 is detailed hereafter. Outer frame members 230 are attached to floor 4 defining a periphery of an area which floor mat system 200 is to cover. Outer frame members 230 define an outer well 201 therebetween and extend around a first mat 202 so that first mat 202 is disposed in outer well 201. First mat 202 has an outer periphery 204 adjacent to or abutting the inside of outer frame members 230. First mat 202 defines an opening 203 in which inner frame members 232 are disposed. Opening 203 has an inner periphery 205 adjacent to or in abutment with an outer periphery 207 of inner frame members 232. Inner frame members 232 define a pair of inner wells 209 each having an inner periphery 208. Logo mat 206 includes two portions 206a and 206b, each removably disposed in a respective inner well 209 and in combination creating a complete logo. Logo mat portions 206a and 206b each have an outer periphery 211 adjacent to and abutting the inside of inner frame members 232 along periphery 208 thereof. Alternately, logo mat 206 may be a single mat as in the first and second embodiments whereby the inner frame member 232 separating logo mat portions 206a and 206b would be eliminated.

As water and debris is scraped from the customer's shoes, it flows through openings 220 into a drainage area under mats 202 and 206. Optional seals may be inserted within outer and inner frame members 230 and 232 to distribute the water and debris evenly beneath floor mat system 200. Floor mats 202 and 206 will eventually have to be removed from wells 290 to allow the water and debris to be cleaned from wells 290. Floor mats 202 and 206 are placed back within wells 290 for subsequent reuse.

Mat 202 and/or 206 may be situated above or near a drain 296 into which the water and at least some of the debris may flow. Seals may be optionally inserted within any of inner frame members 232 to selectively create a desired flow of water to the area of drain 296. Further, seals may be left out of a portion of one of outer frame members 230 in the event a drain is located outside or adjacent to floor mat system 200. The water or debris may be directed toward one side or end of floor mat system 200 creating a flow to an outer drain. Alternatively, floor mats 202 and 206 may be removed from wells 290 to allow the debris to be hosed from wells 290 with a water hose with the directional flow allowing the clean water to exit frame assembly 210 as described above.

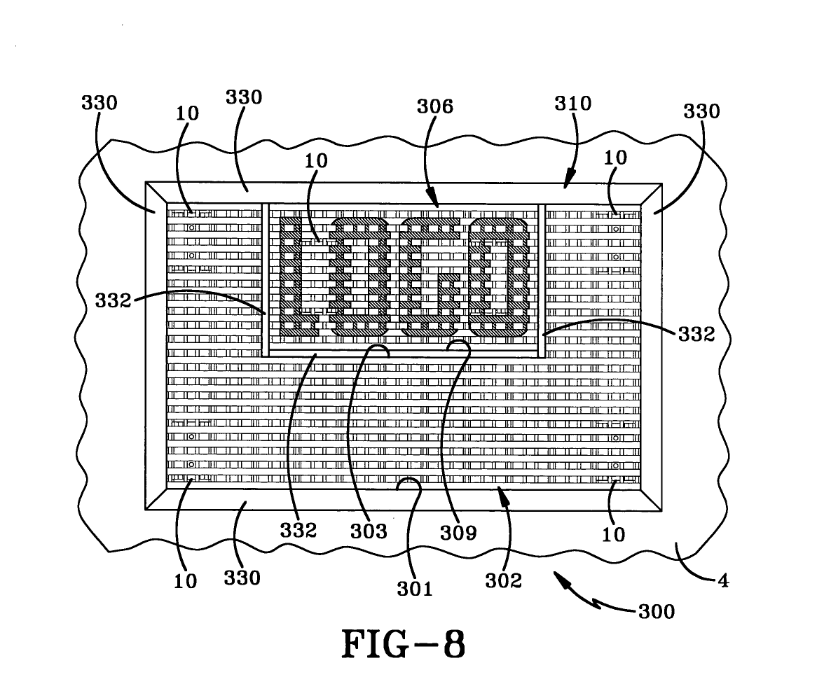

A fourth embodiment of the floor mat system of the present invention is indicated at 300 in FIG. 8. System 300 is similar to system 200 except for the location of logo mat 306, the fact that logo mat 306 is a single mat instead of a pair of logo mat portions, and a change in the frame assembly as a result of the relocation of logo mat 306. More specifically, a frame assembly 310 includes an outer frame member 330 which is substantially the same as outer frame member 230 and defines an outer well 301. Assembly 310 also includes an inner frame member 332 having three sides, two of which extend toward and abut outer frame member 330 to define an inner well 309 between inner frame members 332 and the portion of outer frame member 330 intermediate the two sides of inner frame member 332 abutting outer frame member 330. Logo mat 306 is removably disposed in inner well 309. A first mat 302 is removably disposed within outer well 301 and defines an opening 303 in which inner frame member 332 is disposed.

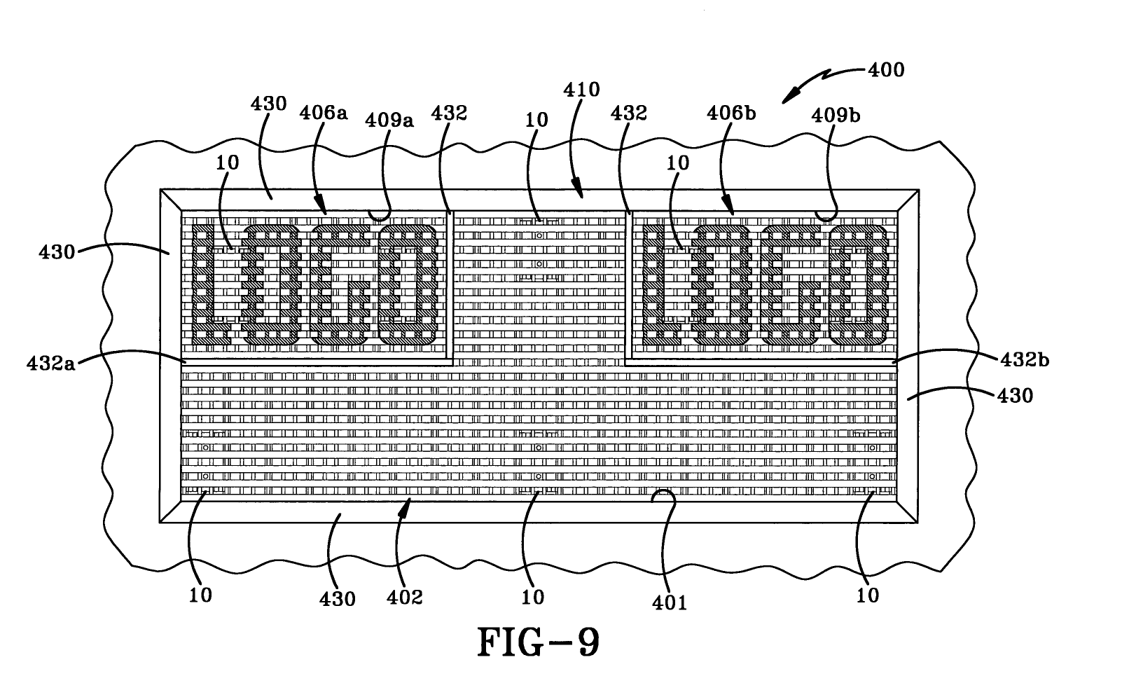

A fifth embodiment of the floor mat system of the present invention is indicated at 400 in FIG. 9. System 400 is similar to system 200 except for the location of logo mat 406, the fact that logo mat 406 is a pair of mats 406a and 406b each having a separate logo instead of a pair of logo mat portions making up a single logo, and a change in the frame assembly as a result of the relocation of logo mat 406. More specifically, a frame assembly 410 includes an outer frame member 430 which is substantially the same as outer frame member 230 except it is further elongated. Outer frame member 430 defines an outer well 401. Assembly 410 also includes a pair of inner frame members 432a and 432b situated generally in respective interior corners of outer well 401. Each inner frame member 432 has two sides, one extending toward and abutting one side of outer frame member 430 and the other extending toward and abutting a second side of outer frame member 430 to define an inner well 409 between inner frame members 432 and the respective portions of outer frame member 430. Thus, inner well 409 includes a first well 409a and a second well 409b. Logo mats 406a and 406b are removably disposed respectively within inner wells 409a and 409b. A first mat 402 is disposed within outer well 401 and defines a pair of openings 403a and 403b in which inner frame member 432a and 432b are respectively disposed.

Accordingly, the floor mat system of the above embodiments is simplified, provides an effective, safe, inexpensive, and efficient device which achieves all the enumerated objectives, provides for eliminating difficulties encountered with prior devices, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

1. A floor mat system adapted to lie on a floor, the floor mat system comprising:
a first mat having an upper surface and a lower surface and defining an opening extending from the upper surface to the lower surface;
a logo mat having an upper surface with discernible indicia carried thereby; and
the logo mat being removably disposed in the opening.

2. The system of claim 1 wherein the logo mat is removably connected to the floor.

3. The system of claim 2 wherein the logo mat comprises:
a plurality of support knobs each having a lower surface adapted to engage the floor; and
at least one clip adapted to hold the logo mat to the floor; the at least one clip engaging the logo mat.

4. The system of claim 3 wherein the at least one clip defines at least one hole in which one of the support knobs is at least partially positioned.

5. The system of claim 3 wherein the first mat is removably connected to the floor.

6. The system of claim 4 wherein the first mat comprises:
a plurality of support knobs each having a lower surface adapted to engage the floor; and
at least one clip adapted to hold the first mat to the floor; the at least one clip engaging the first mat.

7. The system of claim 6 wherein the at least one clip defines at least one hole in which one of the support knobs is at least partially positioned.

8. The system of claim 1 wherein the first mat and the logo mat each have a plurality of support ribs and a plurality of first ribs transverse to the support ribs so as to define a plurality of drainage openings extending between the respective upper and lower surfaces of the first mat and the logo mat.

9. The system of claim 8 wherein the first mat support ribs and the logo mat support ribs each have a lower surface adapted to lie on the floor and each first mat first rib and each logo mat first rib has a lower surface disposed higher than the respective support rib lower surfaces to form drainage channels between adjacent support ribs; the logo mat drainage channels being in fluid communication with the first mat drainage channels.

10. The system of claim 1 wherein the logo mat has a periphery completely surrounded by the first mat.

11. The system of claim 1 wherein the first mat and the logo mat each have a plurality of support ribs each having an upper surface and a lower surface adapted to lie on the floor and a plurality of first ribs disposed transverse to the support ribs; each first rib having an upper surface disposed higher than the respective support rib upper surfaces.

12. The system of claim 1 wherein the indicia is painted on the upper surface of the logo mat.

13. The system of claim 1 wherein the indicia is formed of a laminate adhered to the upper surface of the logo mat.

14. The system of claim 13 wherein the indicia includes a plurality of colors.

15. The system of claim 1 wherein the logo mat includes a plurality of support ribs and a plurality of first ribs transverse to the support ribs; wherein the support ribs and first ribs each have upper surfaces and sides extending downwardly therefrom; and wherein the indicia is disposed on the respective upper surfaces and sides of the support ribs and first ribs.

16. The floor mat of claim 1 wherein at least one inner frame member is disposed in the opening and defines an inner well in which the logo mat is removably disposed.

17. The system of claim 16 wherein the at least one inner frame member has an outer periphery completely surrounded by the first mat.

18. The system of claim 17 wherein the first mat is removably connected to the floor.

19. The system of claim 16 wherein at least one outer frame member forms an outer well within which the inner well is disposed.

20. The system of claim 19 wherein the at least one inner frame member has an outer periphery completely surrounded by the first mat.

21. The system of claim 20 wherein the logo mat has a lower surface; and wherein the first mat and the logo mat each have a plurality of support ribs and a plurality of first ribs transverse to the support ribs so as to define a plurality of drainage openings extending from the respective upper surfaces to the respective lower surfaces of the first mat and the logo mat.

22. The system of claim 21 wherein the first mat support ribs and the logo mat support ribs each have a lower surface adapted to lie on the floor and each first mat first rib and each logo mat first rib has a lower surface disposed higher than the respective support rib lower surfaces to form drainage channels between adjacent support ribs.

23. The system of claim 22 wherein the at least one inner frame member includes at least one drainage passage in fluid communication with at least one of the drainage channels of each of the first mat and the logo mat.

24. The system of claim 23 wherein the at least one outer frame member has a bottom surface in which a seal-receiving recess is formed, a seal being disposed in the recess; the seal being continuous about the circumference of the at least one outer frame member to form a seal between the at least one outer frame member and the floor.

25. The system of claim 19 wherein the at least one outer frame member has a bottom surface in which a seal-receiving recess is formed, a seal being disposed in the recess; the seal being continuous about the circumference of the at least one outer frame member to form a seal between the at least one outer frame member and the floor.

26. The system of claim 19 wherein the at least one inner frame member includes a plurality of inner frame members forming a plurality of inner wells each disposed within the outer well; wherein the logo mat includes a plurality of logo mat portions each having a portion of the indicia thereon; and wherein each inner well removably receives a respective logo mat portion whereby the indicia on the logo mat portions together form a logo.
